(19) United States
(12) Patent Application Publication
(10) Pub. No.: US 2025/0253559 A1
(43) Pub. Date: Aug. 7, 2025

(54) HYBRID CONNECTOR

(71) Applicant: P-TWO INDUSTRIES INC., Taoyuan City (TW)

(72) Inventors: Hsien-Chang LIN, Taoyuan City (TW); Chih-Wei HUANG, Taoyuan City (TW); Pi-Miao CHEN, Taoyuan City (TW); Chia-Chen WEI, Taoyuan City (TW)

(21) Appl. No.: 19/031,829

(22) Filed: Jan. 18, 2025

(30) Foreign Application Priority Data
Feb. 6, 2024 (TW) 113104803
Aug. 8, 2024 (TW) 113129706

(51) Int. Cl. H01R 12/70; H01R 12/71; H01R 12/73; H01R 12/91; H01R 13/502

(52) U.S. Cl. CPC H01R 12/7088; H01R 12/707; H01R 12/716; H01R 12/73; H01R 12/91; H01R 13/502

(57) ABSTRACT

A hybrid connector is disclosed, which comprises an insulating housing, a plurality of signal contacts and a plurality of power source contacts. The insulating housing has a mating portion to be engaged with a mating connector in a first direction. The plurality of signal contacts and the plurality of power source contacts are arranged in a second direction perpendicular to the first direction. The plurality of power source contacts are arranged at two sides of a signal contact group consisting of the plurality of signal contacts and spaced from the signal contact group. When viewed from a third direction perpendicular to both the first and second directions, a central axis of a power-source-side contact portion is offset inwardly in the second direction with respect to a central axis of a power-source-side soldered portion. Accordingly, a thermal impact to the signal contacts can be suppressed.

### CROSS-REFERENCES TO RELATED APPLICATIONS

This application claims the benefit of priority to Taiwanese Patent Application No. 113104803 filed on Feb. 6, 2024 and Taiwanese Patent Application No. 113129706 filed on Aug. 8, 2024, which are hereby incorporated by reference in its entirety.

### BACKGROUND OF THE INVENTION

### Field of the Invention

The present invention relates to a hybrid connector, particularly to a hybrid connector capable of transmitting both signals and electric power.

### Descriptions of the Related Art

It is known to use a floating hybrid connector having a plurality of signal contacts and a plurality of power source contacts for the signal transmission and the electric power transmission between two circuit boards. This type of floating hybrid connector has been disclosed in U.S. Pat. No. 9,484,656B2.

However, in the situation that the layout of solder pads of the circuit boards has been predefined and the external dimensions of the connector are strictly defined, it may be necessary to offset a portion of the power source contact with respect to other portion of the power source contact, on one hand to prevent interference between the power source contact and the stationary housing during movement of the movable housing, and on the other hand to make the gap between the signal contact and the power source contact at a contact side different from the gap between the signal contact and the power source contact at a substrate side (or a soldered side), so as to prevent the signal contact from being affected by the heat generated by the power contact. The connector disclosed in U.S. Pat. No. 9,484,656B2 cannot meet this requirement.

### SUMMARY OF THE INVENTION

One object of the present invention is to provide a hybrid connector wherein the spacing between the power contact and the signal contact at the substrate side is different from the spacing between the power contact and the signal contact at the contact side.

Another object of the present invention is to provide a hybrid connector capable of suppressing the thermal impact on the signal contact caused by the power contact.

A further object of the present invention is to provide a hybrid connector, particularly a floating hybrid connector, capable of absorbing positioning errors of the circuit boards or positioning errors of the board-mounted connectors.

According to the first aspect of the present invention, a hybrid connector is provided, which comprises an insulating housing, a plurality of signal contacts and a plurality of power source contacts, the insulating housing having a mating portion mateable with a mating connector in a first direction,
wherein the plurality of signal contacts and the plurality of power source contacts are arranged in a second direction perpendicular to the first direction, and the plurality of power source contacts are disposed on both sides of a signal contact group formed by the plurality of signal contacts and spaced apart from the signal contact group; and
each power source contact includes a power-source-side soldered portion at one end and a power-source-side contact portion at the other end, when viewed from a third direction perpendicular to both the first direction and second direction, a central axis of the power-source-side contact portion is offset inwardly with respect to a central axis of the power-source-side soldered portion in the second direction, so that a gap between the power-source-side soldered portion and the signal contact group is greater than a gap between the power-source-side contact portion and the signal contact group.

According to the hybrid connector of the present invention, each power-source-side contact comprises: the power-source-side soldered portion, a first power-source-side held portion, a power-source-side offsetting extension portion, a second power-source-side held portion and the power-source-side contact portion, the first power-source-side held portion and the second power-source-side held portion are held by the insulating housing, the first power-source-side held portion extends from the power-source-side soldered portion, the first power-source-side held portion and the second power-source-side held portion are connected by the power-source-side offsetting extension portion, the power-source-side contact portion extends from the second power-source-side held portion, the central axis of the power-source-side contact portion is offset inwardly in the second direction with respect to the central axis of the power-source-side soldered portion by means of the power-source-side offsetting extension portion.

According to the hybrid connector of the present invention, the insulating housing is composed of a first housing and a second housing, the second housing is mounted to the first housing in such a manner that the second housing is immovable with respect to the first housing.

According to the hybrid connector of the present invention, the plurality of signal contacts and the plurality of power source contacts are held by the second housing.

According to the hybrid connector of the present invention, the first housing is in form of an outer frame, and one end of the second housing is in form of a tongue.

According to the hybrid connector of the present invention, the tongue serves as the mating portion.

According to the hybrid connector of the present invention, the insulating housing comprises a first housing and a second housing, and the second housing is mounted to the first housing in such a manner that it is movable in a plane perpendicular to the first direction.

According to the hybrid connector of the present invention, the first power-source-side held portion is held by the first housing, the second power-source-side held portion is held by the second housing, and the power-source-side offsetting extension portion serves as a power-source-side spring portion.

According to the hybrid connector of the present invention, each signal contact comprises: a signal-side soldered portion, a first signal-side held portion, a signal-side spring portion, a second signal-side held portion and a signal-side contact portion, the first signal-side held portion is held by the first housing, the second signal-side held portion is held by the second housing, the first signal-side held portion extends from the signal-side soldered portion, the first signal-side held portion and the second signal-side held portion are connected by the signal-side spring portion, and the signal-side contact portion extends from the second signal-side held portion.

According to the hybrid connector of the present invention, the mating portion is formed on the second housing.

According to the second aspect of the present invention, a hybrid connector is provided, which comprises a first housing, a second housing, a plurality of signal contacts and a plurality of power source contacts, the second housing having a mating portion mateable with a mating connector in a first direction, the second housing being mounted to the first housing in such a manner that it is movable in a plane perpendicular to the first direction,
wherein the plurality of signal contacts and the plurality of power source contacts are arranged in a second direction perpendicular to the first direction, and the plurality of power source contacts are disposed on both sides of a signal contact group formed by the plurality of signal contacts and spaced apart from the signal contact group;
each signal contact includes: a signal-side soldered portion, a first signal-side held portion, a signal-side spring portion, a second signal-side held portion and a signal-side contact portion, the first signal-side held portion is held by the first housing, the second signal-side held portion is held by the second housing, the first signal-side held portion extends from the signal-side soldered portion, the first signal-side held portion and the second signal-side held portion are connected with each other by the signal-side spring portion, and the signal-side contact portion extends from the second signal-side held portion;
each power source contact includes: a power-source-side soldered portion, a first power-source-side held portion, a power-source-side offsetting extension portion, a second power-source-side held portion and a power-source-side contact portion, the first power-source-side held portion is held by the first housing, the second power-source-side held portion is held by the second housing, the first power-source-side held portion extends from the power-source-side soldered portion, the first power-source-side held portion and the second power-source-side held portion are connected with each other by the power-source-side offsetting extension portion, and the power-source-side contact portion extends from the second power-source-side held portion; and
a central axis of the power-source-side offsetting extension portion is offset inwardly in the second direction with respect to a central axis of the power-source-side soldered portion when viewed from a third direction perpendicular to the first direction and the second direction.

According to the hybrid connector of the present invention, each signal contact has a first width, and each power source contact has a second width which is greater than the first width.

According to the hybrid connector of the present invention, the power-source-side offsetting extension portion is formed with a plurality of elongated slots.

According to the hybrid connector of the present invention, the central axis of the power-source-side offsetting extension portion is offset inwardly in the second direction with respect to a central axis of the power-source-side contact portion when viewed from the third direction.

According to the hybrid connector of the present invention, the plurality of signal contacts and the plurality of power source contacts are arranged in the second direction in two rows.

According to the hybrid connector of the present invention, the signal-side offsetting extension portion is bent differently from the power-source-side spring portion when viewed from the second direction.

According to the hybrid connector of the present invention, the power-source-side offsetting extension portion extends longer than the signal-side spring portion.

According to the hybrid connector of the present invention, the signal-side spring portion has a signal-side vertical extension portion extending in the first direction, the power-source-side offsetting extension portion has a power-source-side vertical extension portion extending in the first direction, and the power-source-side vertical extension portion is offset inwardly in the third direction with respect to the signal-side vertical extension portion when viewed from the second direction.

The above and other objects and advantages of the present invention will become apparent from the accompanying drawings and the following detailed description.

### BRIEF DESCRIPTION OF THE DRAWINGS

FIG. 1 is a perspective view of a board-to-board connector assembly according to the first embodiment of the present invention in a mated state.

FIG. 2 is a perspective view of the board-to-board connector assembly according to the first embodiment of the present invention in an unmated state.

FIG. 3 is a front view of the board-to-board connector assembly according to the first embodiment of the present invention in a mated state.

FIG. 4 is a sectional view taken along the line AA in FIG. 3.

FIG. 5 is a perspective view of a floating hybrid connector according to the first embodiment of the present invention.

FIG. 6 is an exploded perspective view of the floating hybrid connector according to the first embodiment of the present invention.

FIG. 7 is a perspective view of signal contacts and power source contacts of the floating hybrid connector according to the first embodiment of the present invention, wherein one signal contact and one power source contact are shown enlarged.

FIG. 8 is a view of the one power source contact, which is shown enlarged in FIG. 7, viewed from the third direction.

FIG. 9 is a view of the signal contacts and the power source contacts of the floating hybrid connector according to the first embodiment of the present invention viewed from the third direction.

FIG. 10 is a perspective view of the signal contact and an insulating high frequency member of the floating hybrid connector according to the first embodiment of the present invention.

FIG. 11 is a perspective view of a non-floating hybrid connector according to the first embodiment of the present invention.

FIG. 12 is an exploded perspective view of the non-floating hybrid connector according to the first embodiment of the present invention.

FIG. 13 is a perspective view of signal contacts and power source contacts of the non-floating hybrid connector according to the first embodiment of the present invention, wherein one signal contact and one power source contact are shown enlarged.

FIG. 14 is a view of the power source contact, which is shown enlarged in FIG. 13, viewed from the third direction

FIG. 15 is a view of the signal contacts and the power source contacts of the non-floating hybrid connector according to the first embodiment of the present invention viewed from the third direction.

FIG. 16 is a perspective view of a board-to-board connector assembly according to the second embodiment of the present invention in a mated state.

FIG. 17 is a perspective view of the board-to-board connector assembly according to the second embodiment of the present invention in an unmated state.

FIG. 18 is a perspective view of a floating hybrid connector according to the second embodiment of the present invention.

FIG. 19 is an exploded perspective view of the floating hybrid connector according to the second embodiment of the present invention.

FIG. 20 is a perspective view of signal contacts and power source contacts of the floating hybrid connector according to the second embodiment of the present invention, wherein one signal contact and one power source contact are shown enlarged.

FIG. 21 is a view of the one power source contact, which is shown enlarged in FIG. 20, viewed from the third direction.

FIG. 22 is a view of the signal contacts and the power source contacts of the floating hybrid connector according to the second embodiment of the present invention viewed from the second direction.

FIG. 23 is a perspective view of a first variant of the power source contact of the floating hybrid connector according to the second embodiment of the present invention.

FIG. 24 is a view of the signal contacts of the floating hybrid connector according to the second embodiment of the present invention and the power source contacts of the first variant viewed from the second direction.

FIG. 25 is a perspective view of a second variant of the power source contact of the floating hybrid connector according to the second embodiment of the present invention.

FIG. 26 is a view of the signal contacts of the floating hybrid connector according to the second embodiment of the present invention and the power source contacts of the second variant viewed from the second direction.

FIG. 27 is a perspective view of a non-floating hybrid connector according to the second embodiment of the present invention.

FIG. 28 is an exploded perspective view of the non-floating hybrid connector according to the second embodiment of the present invention.

FIG. 29 is a perspective view of signal contacts and power source contacts of the non-floating hybrid connector according to the second embodiment of the present invention, wherein one signal contact and one power source contact are shown enlarged.

FIG. 30 is a view of the signal contacts and the power source contacts of the non-floating hybrid connector according to the second embodiment of the present invention viewed from the third direction.

### DETAILED DESCRIPTION OF THE PREFERRED EMBODIMENT

The board-to-board connector assembly according to the embodiments of the present invention will be described with reference to the drawings. In the drawings, the same components or components with similar functions are denoted by the same reference numerals. The drawings are not necessarily drawn to scale.

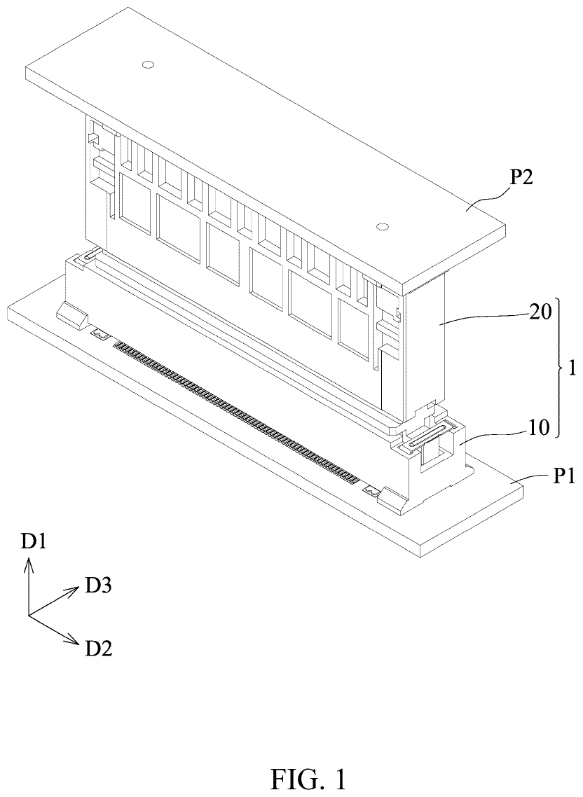

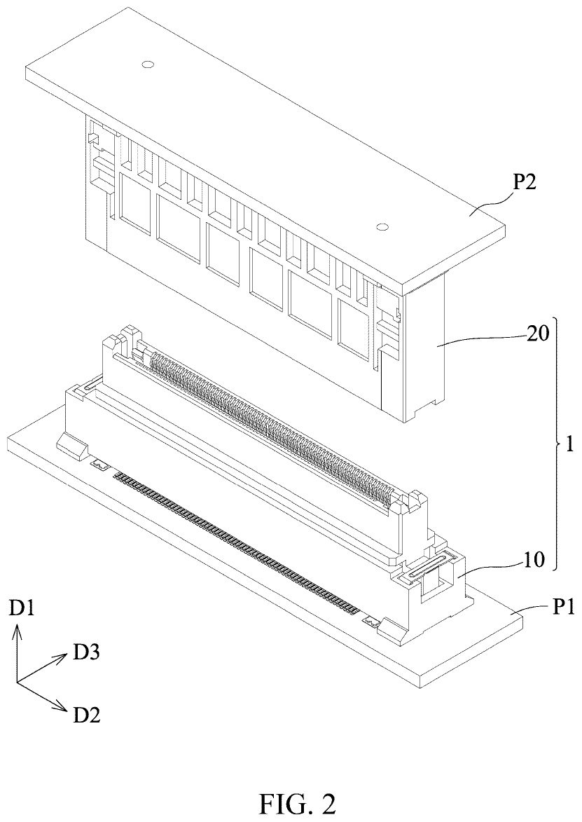

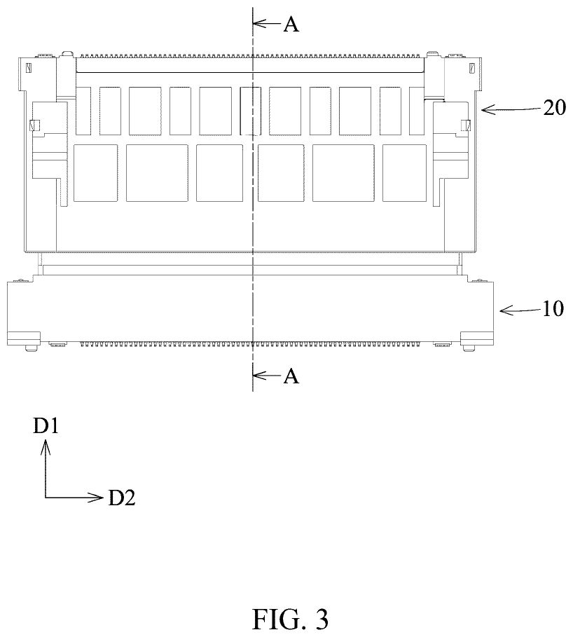

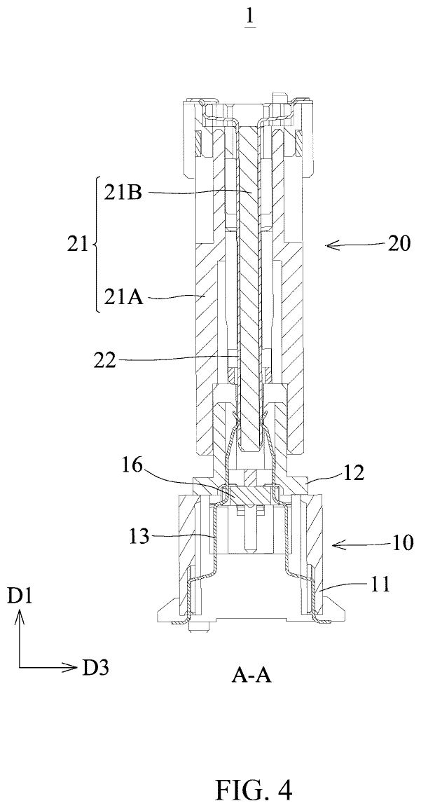

The elements of the board-to-board connector assembly according to the first embodiment of the present invention are briefly described by referring to FIGS. 1, 2, 3 and 4, wherein FIG. 1 is a perspective view of the board-to-board connector assembly according to the first embodiment of the present invention in a mated state, FIG. 2 is a perspective view of the board-to-board connector assembly according to the first embodiment of the present invention in an unmated state, FIG. 3 is a front view of a board-to-board connector assembly according to the embodiment of the present invention in a mated state, and FIG. 4 is a sectional view taken along the line AA in FIG. 3. The board-to-board connector assembly is designated as a whole by the reference numeral “1”.

The board-to-board connector assembly 1 according to the first embodiment comprises a floating hybrid connector 10 and a non-floating hybrid connector 20. The non-floating hybrid connector 20 is a mating connector for the floating hybrid connector 10. The floating hybrid connector 10 and the non-floating hybrid connector 20 are mateable with each other in a first direction D1. The floating hybrid connector 10 is mounted to a first circuit board P1 by using surface mount technology (SMT), and the non-floating hybrid connector 20 is mounted to a second circuit board P2 by using surface mount technology (SMT). Electrical connection between the first circuit board P1 and the second circuit board P2 is established by means of the board-to-board connector assembly 1. Since the floating hybrid connector 10 has a movable housing which is floatable, the floating hybrid connector 10 is capable of absorbing positioning errors of the connectors or the circuit boards. As shown in FIG. 4, when the floating hybrid connector 10 and the non-floating hybrid connector 20 mate with each other, the contacts of the floating hybrid connector 10 and the contacts of the non-floating hybrid connector 20 are in contact with each other, thereby establishing the electrical connection between the first circuit board P1 and the second circuit board P2.

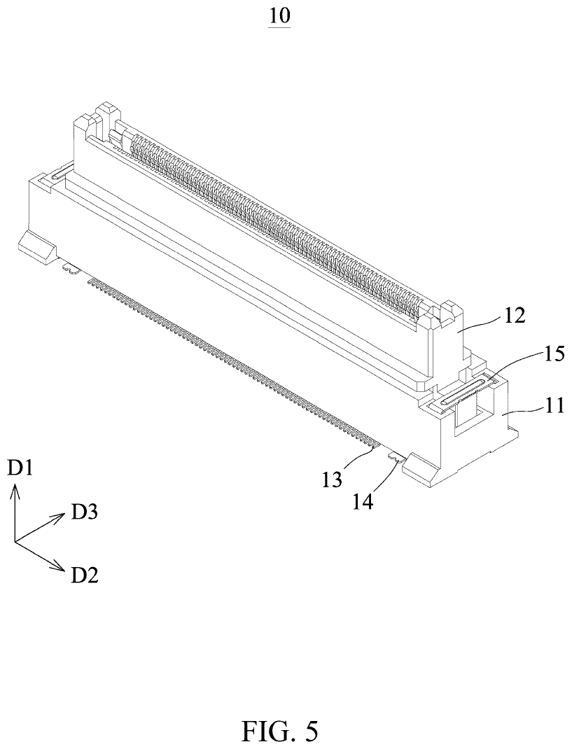

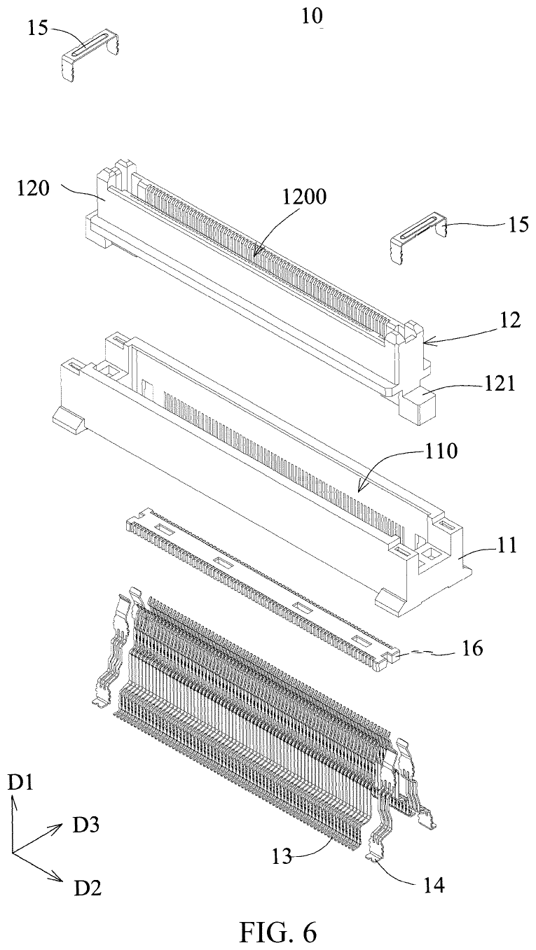

The floating hybrid connector 10 according to the first embodiment of the present invention is described by referring to FIGS. 5 and 6, wherein FIG. 5 is a perspective view of the floating hybrid connector 10 according to the first embodiment of the present invention, and FIG. 6 is an exploded perspective view of the floating hybrid connector 10 according to the first embodiment of the present invention. As shown in FIGS. 5 and 6, the floating hybrid connector 10 comprises a first housing 11 serving as a stationary housing, a second housing 12 serving as a movable housing, a plurality of signal contacts 13 and a plurality of power source contacts 14. The first housing 11 and the second housing 12 are made of insulating resin material or polymer material by using injection molding. The signal contacts 13 and the power source contacts 14 are made of electrically conductive material (such as copper or copper alloy).

The first housing 11 has an accommodation space 110, and the lower portion of the second housing 12 is received in the accommodation space 110. A gap exists between the first housing 11 and the second housing 12 and allows the second housing 12 to move with respect to the first housing 11 in a plane perpendicular to the first direction D1.

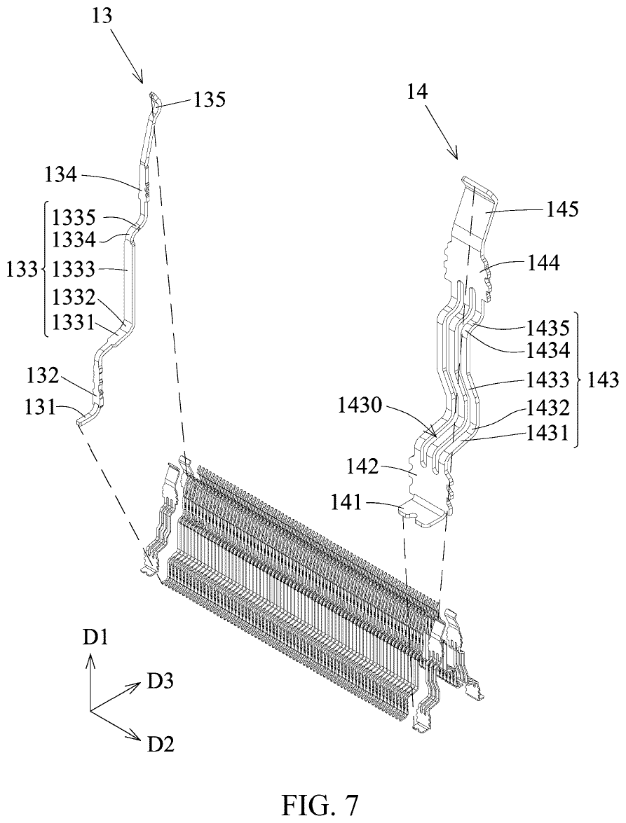

The second housing 12 has a main body 120 and two limiting blocks 121 formed at the two ends of the main body 120, respectively. The main body 120 of the second housing 12 is formed with a mating opening 1200 serving as a mating portion. Two U-shaped metal fittings 15 are respectively mounted at the two ends of the first housing 11 so as to interfere with the limiting blocks 121. The U-shaped metal fittings 15 are used to prevent the second housing 12 from moving in the first direction D1 and to prevent the second housing 12 from being detached from the first housing 11. In this way, the second housing 12 is restricted to be movable with respect to the first housing 11 only in a plane perpendicular to the first direction D1. FIG. 7 is a perspective view of the signal contacts 13 and the power source contacts 14, wherein one signal contact 13 and one power source contact 14 are shown enlarged. As shown in FIG. 7, the signal contacts 13 and the power source contacts 14 are arranged in two rows in a second direction D2 perpendicular to the first direction D1. The two rows of contacts are mirror-symmetrical to each other. In each row of contacts, two power source contacts 14 are respectively disposed on both sides of a signal contact group formed by the signal contacts 13 and spaced apart from the signal contact group. However, the present invention is not limited thereto, and the two power source contacts 14 may be disposed on the same side of the signal contact group in each row of contacts. In this embodiment, only one power source contact is disposed on each side of the signal contact group in each row of contacts. If necessary, two or more power source contacts may be disposed on each side of the signal contact group.

In this embodiment, the floating hybrid connector 10 has 140 signal contacts 13 and four power source contacts 14. However, the present invention is not limited thereto, and the number of signal contacts or power source contacts can be increased or decreased optionally.

Each signal contact 13 comprises: a signal-side soldered portion 131, a first signal-side held portion 132, a signal-side spring portion 133, a second signal-side held portion 134 and a signal-side contact portion 135. The first signal-side held portion 132 extends from the signal-side soldered portion 131. The first signal-side held portion 132 and the second signal-side held portion 134 are connected by the signal-side spring portion 133 which allows the second signal-side held portion 134 to be movable with respect to the first signal-side held portion 132. The signal-side contact portion 135 extends from the second signal-side held portion 134. The signal-side soldered portion 131 will be fixed to the circuit board by using surface mount technology (SMT). The first signal-side held portion 132 formed with a barb structure is press-fitted into the first housing 11 and is held by the first housing 11. The second signal-side held portion 134 formed with a barb structure is press-fitted into the second housing 12 and is held by the second housing 12.

The signal-side spring portion 133 of the signal contact 13 comprises: a first extension portion 1331, a first bent portion 1332, a second extension portion 1333, a second bent portion 1334 and a third extension portion 1335 in this older. The first extension portion 1331 and the third extension portion 1335 extend obliquely with respect to the first direction D1 when viewed from the second direction D2. The second extension portion 1333 extends in a direction parallel to the first direction D1.

Each power source contact 14 comprises: a power-source-side soldered portion 141, a first power-source-side held portion 142, a power-source-side offsetting extension portion 143, a second power-source-side held portion 144 and a power-source-side contact portion 145. The first power-source-side held portion 142 extends from the power-source-side soldered portion 141. The first power-source-side held portion 142 and the second power-source-side held portion 144 are connected by the power-source-side offsetting extension portion 143. The power-source-side contact portion 145 extends from the second power-source-side held portion 144. The power-source-side soldered portion 141 will be fixed to the circuit board by using surface mount technology (SMT). The first power-source-side held portion 142 formed with a barb structure is press-fitted into the first housing 11 and is held by the first housing 11. The second power-source-side held portion 144 formed with a barb structure is press-fitted into the second housing 12 and is held by the second housing 12.

The power-source-side offsetting extension portion 143 of the power source contact 14 comprises: a first extension portion 1431, a first bent portion 1432, a second extension portion 1433, a second bent portion 1434 and a third extension portion 1435 in this older. The first extension portion 1431 and the third extension portion 1435 extend obliquely with respect to the first direction D1 when viewed from the second direction D2. When viewed from the third direction D3 perpendicular to the first direction D1 and the second direction D2, the second extension portion 1433 includes a section extending obliquely with respect to the first direction D1, so that the second power-source-side held portion 144 and the power-source-side contact portion 145 are offset with respect to the power-source-side soldered portion 141 and the first power-source-side held portion 142. In this embodiment, the power-source-side offsetting extension portion 143 of the power source contact 14 of the floating hybrid connector 10 serves as a power-source-side spring portion allowing the second power-source-side held portion 144 to be elastically displaced with respect to the first power-source-side held portion 142.

The signal-side contact portion 135 of the signal contact 13 and the power-source-side contact portion 145 of the power source contact 14 are located in the mating opening 1200 of the second housing 12 so as to be in contact with the contacts of the mating connector.

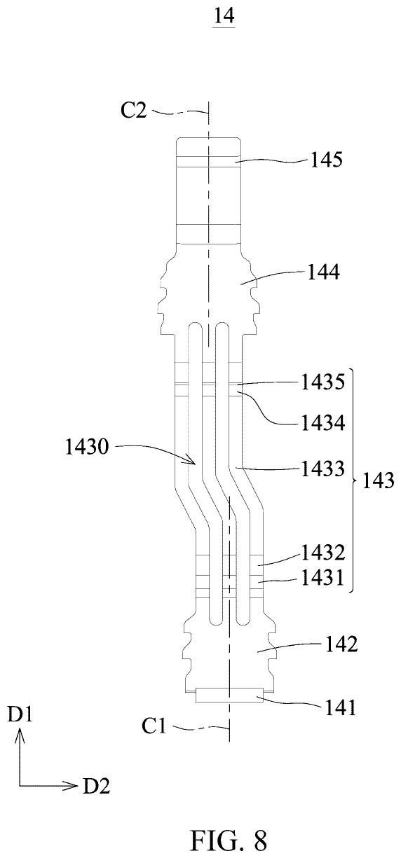

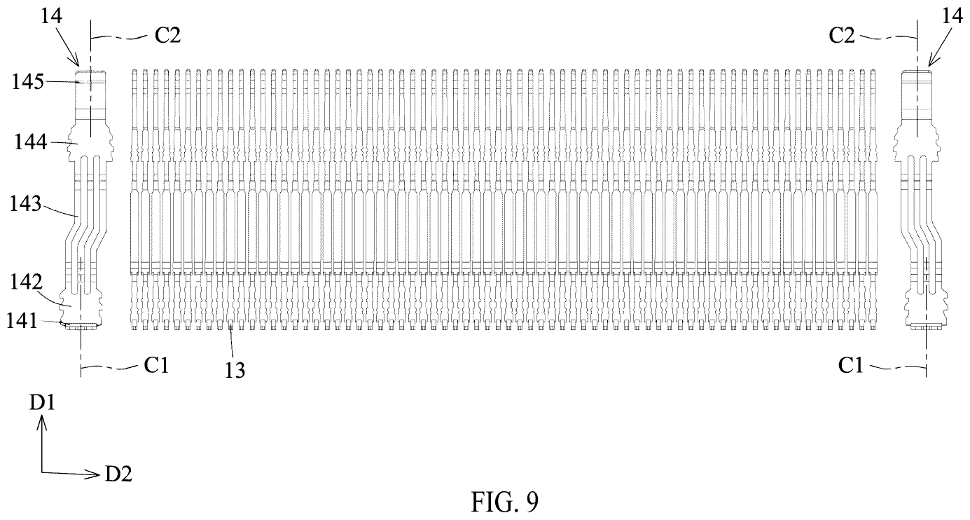

FIG. 8 is a view of the power source contact 14, which is shown enlarged in FIG. 7, viewed from the third direction D3. FIG. 9 is a view of the signal contacts 13 and the power source contacts 14, viewed from the third direction D3. As shown in FIG. 8, the power source contact 14 is configured such that the central axis C2 of the power-source-side contact portion 145 is offset towards the leftward direction of the drawing sheet (i.e., the direction towards the central portion of the connector) with respect to the central axis C1 of the power-source-side soldered portion 141. In other words, the power-source-side offsetting extension portion 143 causes the central axis C2 of the power-source-side contact portion 145 to be offset towards the leftward direction of the drawing sheet (i.e., the direction towards the central portion of the connector) in the second direction D2 with respect to the central axis C1 of the power-source-side soldered portion 141 so that the gap between the power-source-side soldered portion 141 and the signal contact group becomes larger than the gap between the power-source-side contact portion 145 and the signal contact group. This configuration allows the gap between the power contact and the signal contact at the substrate side to be different from the gap between the power contact and the signal contact at the contact side. As a result, as shown in FIG. 9, the power contact is configured such that the gap between the power contact and the signal contact at the substrate side is larger than the gap between the power contact and the signal contact at the contact side.

Since the temperature of the power-source-side soldered portion increases when electric power is transmitted through the power contact, the adjacent signal contacts may be disadvantageously affected. Once the temperature of a signal contact increases, its resistive characteristics may change, causing the signal transmitted by the signal contact to attenuate. This may cause abnormal signal transmission. Therefore, by means of the power contacts of the present invention, the thermal impact on the signal contacts can be suppressed, and the reliability of signal transmission of the connector can be improved.

Since the power source contact 14 has a larger width than the signal contact 13, the power-source-side offsetting extension portion 143 of the power source contact 14 serving as a spring portion has a greater stiffness as compared with the signal-side spring portion 133 of the signal contact 13. In order to promote the floatability of the second housing, it is very beneficial to reduce the stiffness of the power-source-side offsetting extension portion 143 of the power source contact 14 and make it easier to deform.

As can be seen in FIG. 7 and FIG. 8, a plurality of elongated slots 1430 extending longitudinally are formed in the power-source-side offsetting extension portion 143 of the power source contact 14. The power-source-side offsetting extension portion 143 is weakened by formation of the elongated slots 1430.

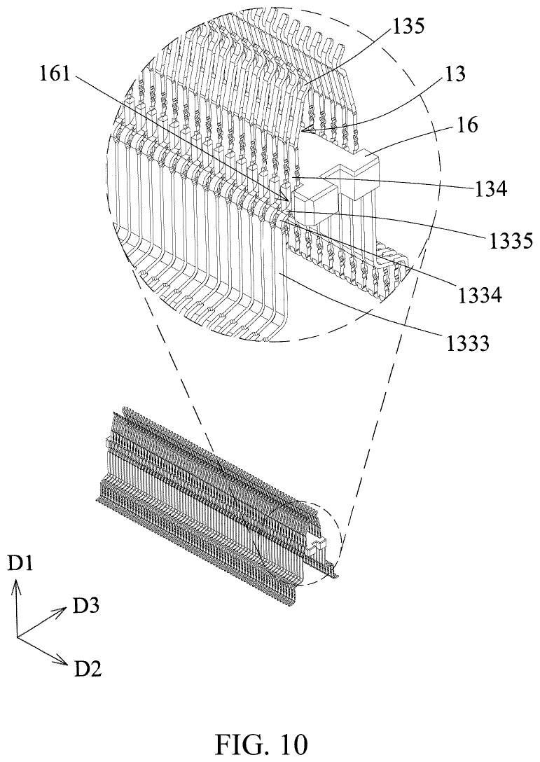

The floating hybrid connector 10 further includes an insulating high frequency member 16. The insulating high frequency member 16 is attached to the bottom of the second housing 12. The insulating high frequency member 16 is configured to partially surround an exposed portion of each signal contact 13 so as to improve the high-frequency characteristics of the signal contacts 13. For convenience of illustration, only the signal contacts 13 and the insulating high frequency member 16 are shown in FIG. 10. As shown in FIG. 10, the insulating high frequency member 16 includes a plurality of receiving notches 161. The receiving notches 161 are arranged at predetermined intervals in the second direction. Each receiving notches 161 is configured to receive a portion, adjacent to the second signal-side held portion 134, of the respective signal contact 13.

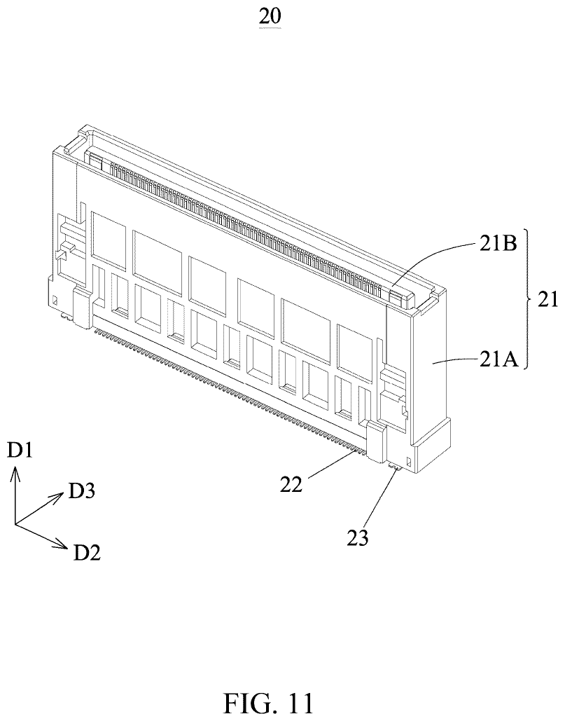

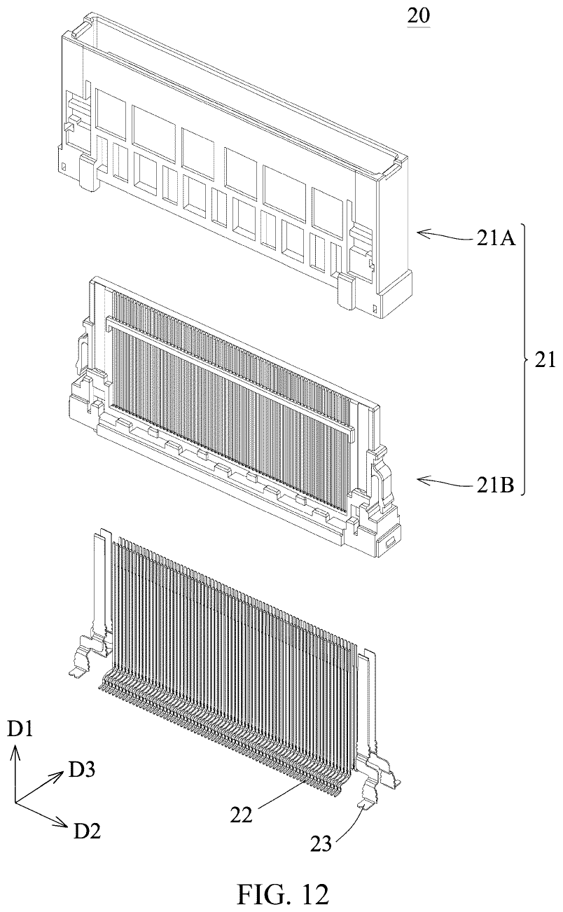

The non-floating hybrid connector 20 which is mateable with the floating hybrid connector 10 will be described with reference to FIGS. 11 and 12, wherein FIG. 11 is a perspective view of the non-floating connector 20, and FIG. 12 is an exploded perspective view of the non-floating hybrid connector 20.

The non-floating hybrid connector 20 comprises an insulating housing 21, a plurality of signal contacts 22, and a plurality of power source contacts 23. The insulating housing 21 is a two-piece housing composed of a first housing 21A and a second housing 21B. Each of the first housing 21A and the second housing 21B is made of insulating resin material or polymer material by injection molding. The signal contacts 22 and power source contacts 23 are made of electrically conductive material (such as copper or copper alloy). The insulating housing 21 is a stationary housing.

The first housing 21A is in form of an outer frame, and one end of the second housing 21B is in form of a tongue. The tongue serves as the mating portion of the non-floating hybrid connector 20. The second housing 21B is arranged within the first housing 21A in such a manner that it is immovable with respective to the first housing 21A.

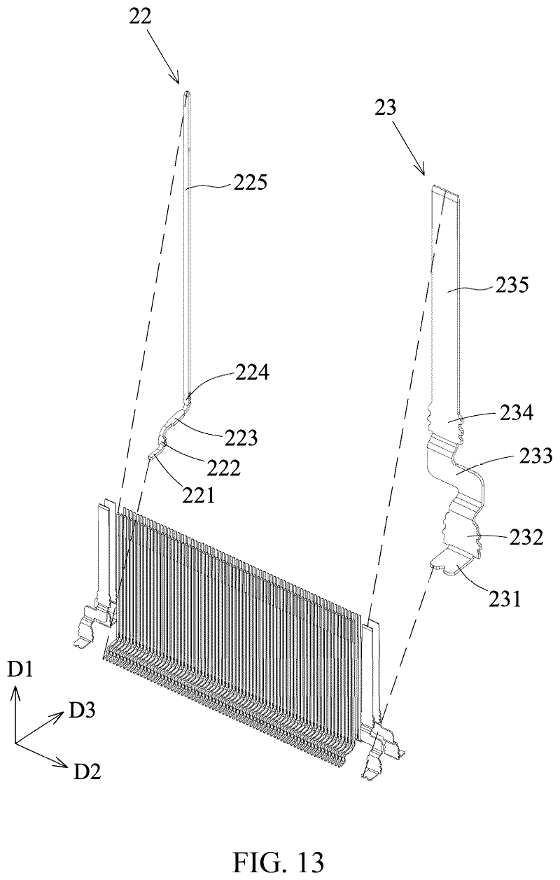

FIG. 13 is a perspective view of the signal contacts 22 and the power source contacts 23. As shown in FIG. 13, the signal contacts 22 and the power source contacts 23 are arranged in the second direction D2 perpendicular to the first direction D1 in two rows. The two rows of contacts are mirror-symmetrical to each other. In each row of the contacts, two power source contacts 23 are respectively disposed on both sides of a signal contact group formed by signal contacts 22 and spaced apart from the signal contact group. However, the present invention is not limited thereto. The layout of the contacts of the non-floating hybrid connector depends on the layout of the contacts of the floating hybrid connector.

Each signal contact 22 comprises: a signal-side soldered portion 221, a first signal-side held portion 222, a signal-side bent extension portion 223, a second signal-side held portion 224, and a signal-side contact portion 225. The first signal-side held portion 222 extends from the signal-side soldered portion 221. The first signal-side held portion 222 and the second signal-side held portion 224 are connected by the signal-side bent extension portion 223. The signal-side contact portion 225 extends from the second signal-side held portion 224. The signal-side soldered portion 221 will be fixed to the circuit board by using surface mount technology (SMT). The first signal-side held portion 222 and the second signal-side held portion 224 each of which is formed with a barb structure are press-fitted into the second housing 21B and are held by the second housing 21B.

Each power source contact 23 comprises: a power-source-side soldered portion 231, a first power-source-side held portion 232, a power-source-side offsetting extension portion 233, a second power-source-side held portion 234, and a power-source-side contact portion 235. The first power-source-side held portion 232 extends from the power-source-side soldered portion 231. The first power-source-side held portion 232 and the second power-source-side held portion 234 are connected by the power-source-side offsetting extension portion 233. The power-source-side contact portion 235 extends from the second power-source-side held portion 234. The power-source-side soldered portion 231 will be fixed to the circuit board by using surface mount technology (SMT). The first power-source-side held portion 232 and the second power-source-side held portion 234 each of which is formed with a barb structure are press-fitted into the second housing 21B and are held by the second housing 21B.

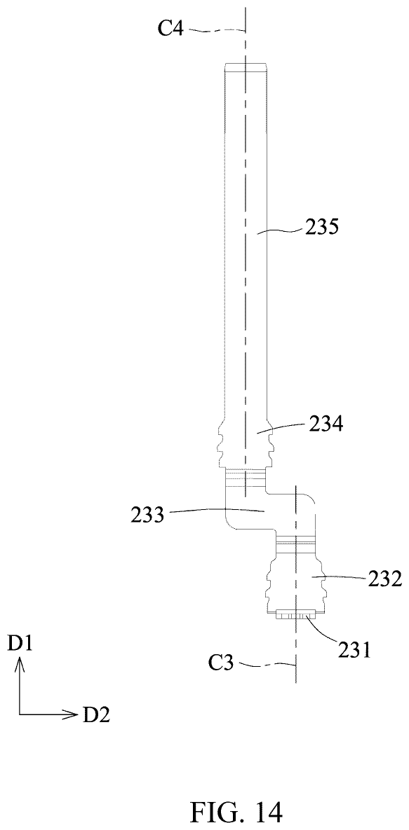

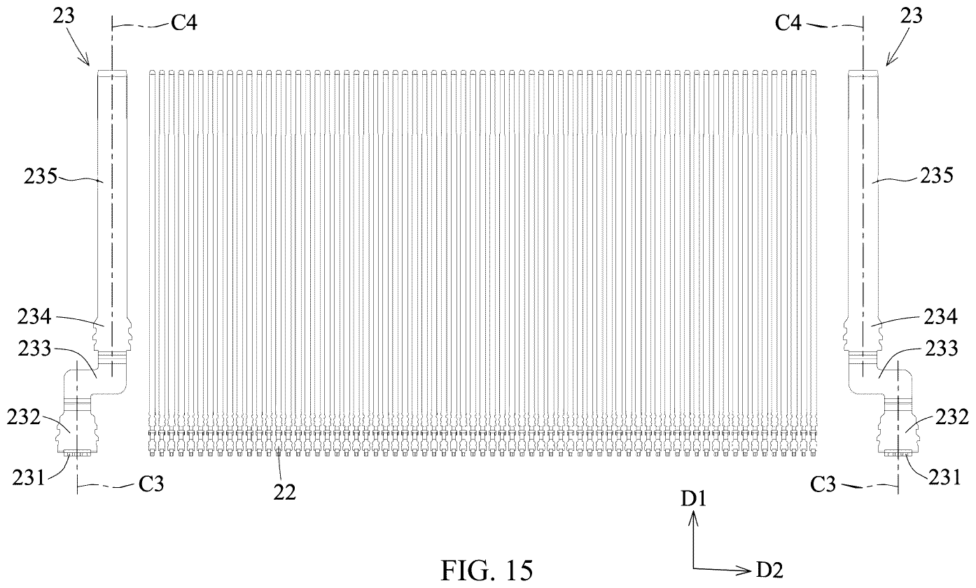

FIG. 14 is a view of the power contact 23, which is shown enlarged in FIG. 13, viewed from the third direction D3. FIG. 15 is a view of the signal contacts 22 and the power source contacts 23 viewed from the third direction D3. As shown in FIG. 14, the power source contact 23 is configured such that the central axis C4 of the power-source-side contact portion 235 is offset towards the leftward direction of the drawing sheet (i.e., the direction towards the central portion of the connector) with respect to the central axis C3 of the power-source-side soldered portion 231. In other words, the power-source-side offsetting extension portion 233 causes the central axis C4 of the power-source-side contact portion 235 to be offset towards the leftward direction of the drawing sheet (i.e., the direction towards the central portion of the connector) in the second direction D2 with respect to the central axis C3 of the power-source-side soldered portion 231 so that the gap between the power-source-side soldered portion 231 and the signal contact group becomes larger than the gap between the power-source-side contact portion 235 and the signal contact group. As shown in FIG. 15, with aid of the power-source-side contact portion 235 which is offset with respect to the power-source-side soldered portion 231, the gap between the power-source-side soldered portion 231 and the signal contact group is made larger than the gap between the power-source-side contact portion 235 and the signal contact group.

It should be understood that the insulating housing 21 is a two-piece housing in this embodiment, but the invention is not limited thereto. The insulating housing 21 can be made as a single piece housing. Although in this embodiment, the signal contacts and the power contacts are held merely by the second housing 21B, the invention is not limited thereto. In the case of a two-piece housing, each of the signal contacts and the power contacts can be held by the first housing and the second housing.

Furthermore, the hybrid connector according to the present invention can be embodied as a floating hybrid connector or a non-floating hybrid connector.

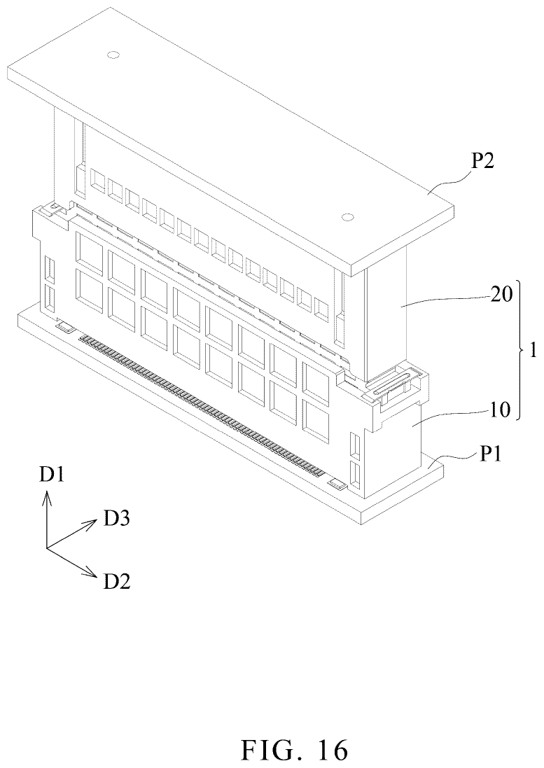

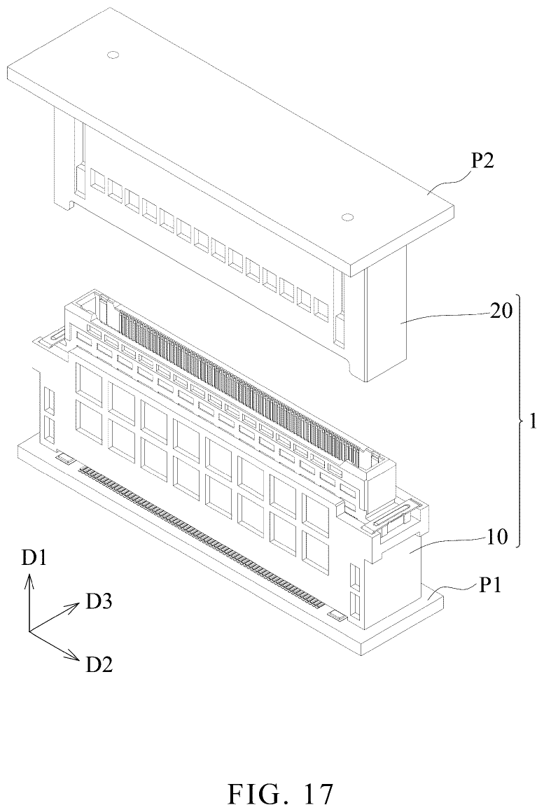

The elements of the board-to-board connector assembly according to the second embodiment of the present invention are briefly described by referring to FIGS. 16 and 17, wherein FIG. 16 is a perspective view of the board-to-board connector assembly according to the second embodiment of the present invention in a mated state, and FIG. 17 is a perspective view of the board-to-board connector assembly according to the second embodiment of the present invention in an unmated state. The board-to-board connector assembly is designated as a whole by the reference numeral “1”.

The board-to-board connector assembly 1 according to the second embodiment of the present invention comprises a floating hybrid connector 10 and a non-floating hybrid connector 20 which mates with the floating hybrid connector 10. The floating hybrid connector 10 and the non-floating hybrid connector 20 are mateable with each other in the first direction D1. The floating hybrid connector 10 is mounted to a first circuit board P1 by using surface mount technology (SMT), and the non-floating hybrid connector 20 is mounted to a second circuit board P2 by using surface mount technology (SMT). Electrical connection between the first circuit board P1 and the second circuit board P2 is established by means of the board-to-board connector assembly 1. Since the floating hybrid connector 10 has a movable housing which is floatable, the floating hybrid connector 10 is capable of absorbing positioning errors of the connectors or the circuit boards.

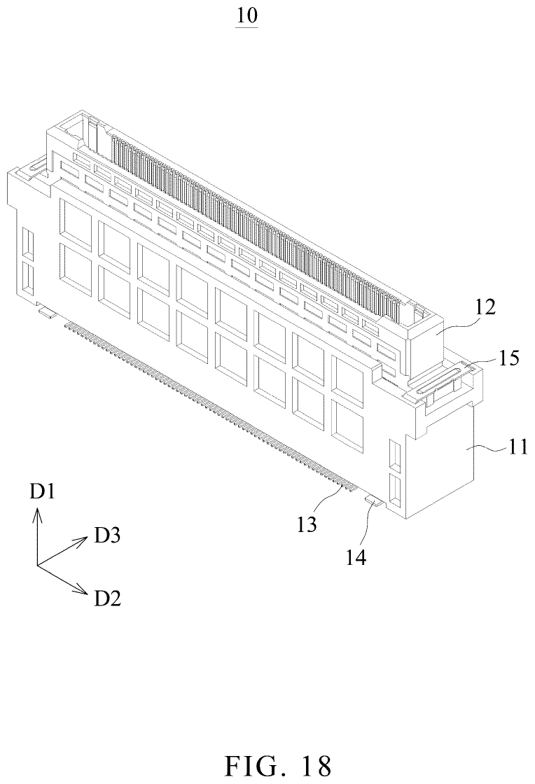

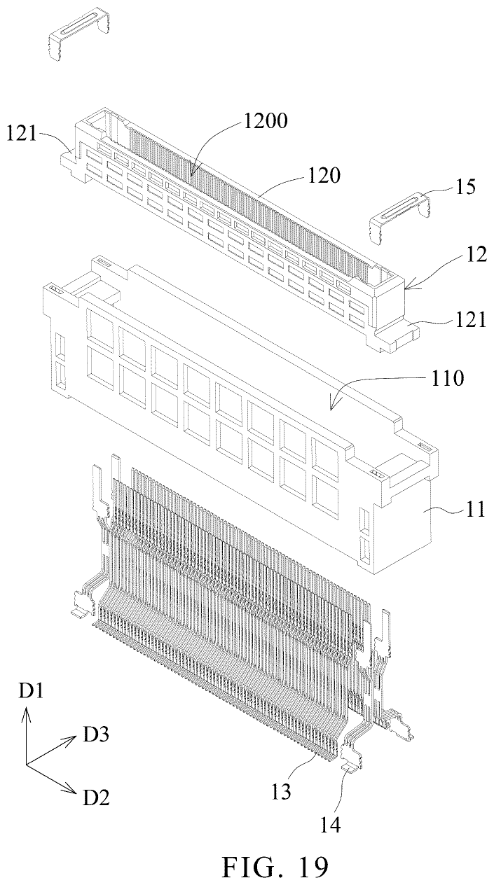

The floating hybrid connector 10 according to the second embodiment of the present invention is described by referring to FIGS. 18 and 19, wherein FIG. 18 is a perspective view of the floating hybrid connector 10 according to the second embodiment of the present invention, and FIG. 19 is an exploded perspective view of the floating hybrid connector 10 according to the second embodiment of the present invention. As shown in FIGS. 18 and 19, the floating hybrid connector 10 comprises a first housing 11 serving as a stationary housing, a second housing 12 serving as a movable housing, a plurality of signal contacts 13 and a plurality of power source contacts 14. The first housing 11 and the second housing 12 are made of insulating resin material or polymer material by using injection molding. The signal contacts 13 and the power source contacts 14 are made of electrically conductive material (such as copper or copper alloy).

The first housing 11 has a receiving space 110, and the lower portion of the second housing 12 is received in the receiving space 110. A gap exists between the first housing 11 and the second housing 12 and allows the second housing 12 to move with respect to the first housing 11 in a plane perpendicular to the first direction D1.

The second housing 12 has a main body 120 and two limiting blocks 121 formed at the two ends of the main body 120, respectively. The main body 120 of the second housing 12 is formed with a mating opening 1200 serving as a mating portion. Two U-shaped metal fittings 15 are respectively mounted at the two ends of the first housing 11 so as to interfere with the limiting blocks 121. The U-shaped metal fittings 15 are used to prevent the second housing 12 from moving in the first direction D1 and to prevent the second housing 12 from being detached from the first housing 11. In this way, the second housing 12 is restricted to be movable with respect to the first housing 11 only in a plane perpendicular to the first direction D1.

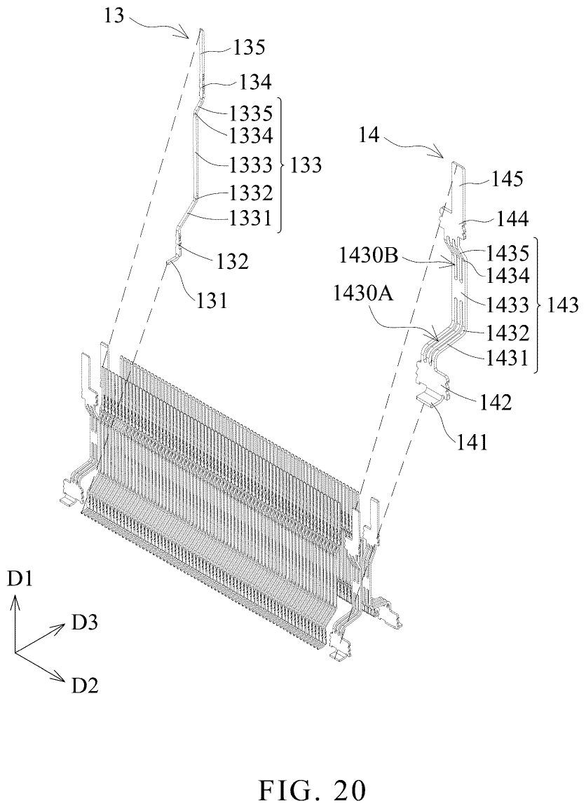

FIG. 20 is a perspective view of the signal contacts 13 and the power source contacts 14 of the floating hybrid connector 10 according to the second embodiment of the present invention. As shown in FIG. 20, the signal contacts 13 and the power source contacts 14 are arranged in two rows in the second direction D2 perpendicular to the first direction D1. The two rows of contacts are mirror-symmetrical to each other. In each row of contacts, two power source contacts 14 are respectively disposed on both sides of a signal contact group formed by signal contacts 13 and spaced apart from the signal contact group. However, the present invention is not limited thereto, and the two power source contacts 14 may be disposed on the same side of the signal contact group in each row of contacts. Although in this embodiment, only one power source contact is disposed on each side of the signal contact group in each row of contacts, if necessary, two or more power source contacts may be disposed on each side of the signal contact group.

In this embodiment, the floating hybrid connector 10 has 140 signal contacts 13 and four power source contacts 14. However, the present invention is not limited thereto, and the number of signal contacts or power source contacts can be increased or decreased optionally.

Each signal contact 13 comprises: a signal-side soldered portion 131, a first signal-side held portion 132, a signal-side spring portion 133, a second signal-side held portion 134 and a signal-side contact portion 135. The first signal-side held portion 132 extends from the signal-side soldered portion 131. The first signal-side holding portion 132 and the second signal-side holding portion 134 are connected by the signal-side spring portion 133. The signal-side contact portion 135 extends from the second signal-side held portion 134. The signal-side soldered portion 131 will be fixed to the circuit board by using surface mount technology (SMT). The first signal-side held portion 132 formed with a barb structure is press-fitted into the first housing 11 and is held by the first housing 11. The second signal-side held portion 134 formed with a barb structure is press-fitted into the second housing 12 and is held by the second housing 12.

The signal-side spring portion 133 of the signal contact 13 comprises: a first extension portion 1331, a first bent portion 1332, a second extension portion 1333, a second bending portion 1334 and a third extension portion 1335 in this older. The first extension portion 1331 and the third extension portion 1335 extend obliquely with respect to the first direction D1. The second extension portion 1333 extends in the first direction D1.

Each power source contact 14 comprises: a power-source-side soldered portion 141, a first power-source-side held portion 142, a power-source-side offsetting extension portion 143, a second power-source-side held portion 144 and a power-source-side contact portion 145. The first power-source-side held portion 142 extends from the power-source-side soldered portion 141. The first power-source-side held portion 142 and the second power-source-side held portion 144 are connected by the power-source-side offsetting extension portion 143. The power-source-side contact portion 145 extends from the second power-source-side held portion 144. The power-source-side soldered portion 141 will be fixed to the circuit board by using surface mount technology (SMT). The first power-source-side held portion 142 formed with a barb structure is press-fitted into the first housing 11 and is held by the first housing 11. The second power-source-side held portion 144 formed with a barb structure is press-fitted into the second housing 12 and is held by the second housing 12.

The power-source-side offsetting extension portion 143 of the power source contact 14 comprises: a first extension portion 1431, a first bent portion 1432, a second extension portion 1433, a second bent portion 1434 and a third extension portion 1435 in this older. The first extension portion 1431 and the third extension portion 1435 extend obliquely with respect to the first direction D1. The second extension portion 1433 extends in the first direction D1.

The signal-side contact portion 135 of the signal contact 13 and the power-source-side contact portion 145 of the power source contact 14 are located in the mating opening 1200 of the second housing 12 so as to be in contact with the contacts of a mating connector.

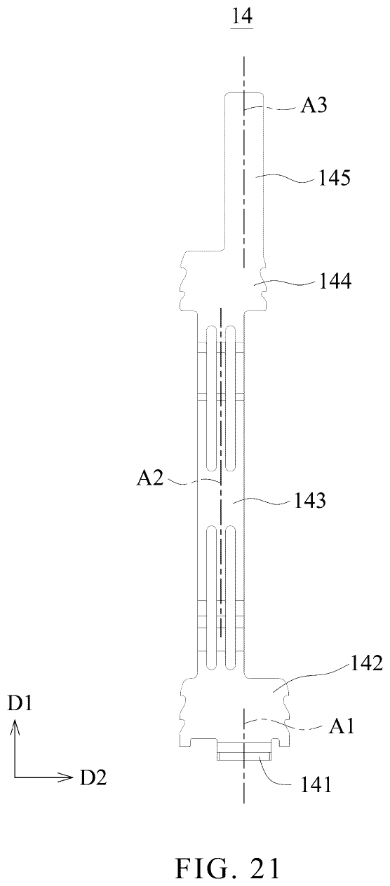

FIG. 21 is a view of the power source contact 14, which is shown enlarged in FIG. 20, viewed from the third direction D3. As shown in FIG. 21, the power source contact 14 is configured such that the central axis A2 of the power-source-side offsetting extension portion 143 is offset in the leftward direction of the drawing sheet (i.e., the direction towards the central portion of the connector) with respect to the central axis A1 of the power-source-side soldered portion 141 and the central axis A3 of the power-source-side contact portion 145. This prevents interference between the power source contact 14 and the first housing 11 during movement of the second housing 12 with respect to the first housing 11.

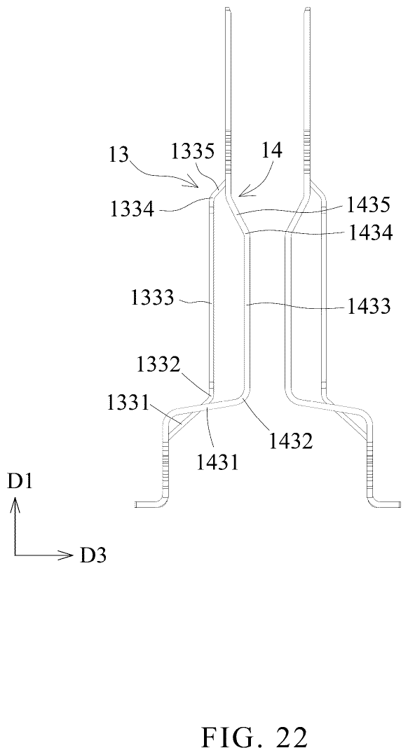

FIG. 22 is a view of the signal contacts 13 and the power source contacts 14 of the floating hybrid connector 10 according to the second embodiment of the present invention, viewed from the second direction D2. In FIG. 22, the signal-side soldered portion, the first signal-side held portion, the second signal-side held portion and the signal-side contact portion of the signal contact 13 substantially overlap those of the power source contact 14, while the signal-side spring portion of the signal contact 13 is bent differently from the power-source-side offsetting extension portion of the power source contact 14. This is very different from the prior art. In known floating hybrid connectors, to facilitate manufacturing, the spring portion of the power source contact and the spring portion of the signal contact typically have the same or similar bent structure.

Since the power source contact 14 has a larger width than the signal contact 13, the power-source-side offsetting extension portion 143 of the power source contact 14 has a greater stiffness as compared with the signal-side spring portion 133 of the signal contact 13. In order to promote the floatability of the second housing, it is very beneficial to reduce the stiffness of the power-source-side offsetting extension portion 143 of the power source contact 14 and make it easier to deform.

As can be seen in FIG. 20, a plurality of elongated slots 1430A and 1430B extending longitudinally are formed in the power-source-side offsetting extension portion 143 of the power source contact 14, wherein the elongated slots 1430A are spaced apart from the elongated slots 1430B. The power-source-side offsetting extension portion 143 is weakened by formation of the elongated slots 1430A and 1430B.

It is also possible to reduce the stiffness of the power-source-side offsetting extension portion 143 by lengthening the power-source-side offsetting extension portion 143. As shown in FIG. 22, the power-source-side offsetting extension portion 143 of the power source contact 14 has a vertical extension portion (i.e., the second extension portion 1433) extending in the first direction D1, and the signal-side spring portion 133 of the signal contact 13 has a vertical extension portion (i.e., the second extension portion 1333) extending in the first direction D1.

The power-source-side offsetting extension portion 143 of the power source contact 14 is configured such that the vertical extension portion (i.e., the second extension portion 1433) of the power-source-side offsetting extension portion 143 is offset inwardly in the third direction D3 with respect to the vertical extension portion (i.e., the second extension portion 1333) of the signal-side spring portion 133. In this way, the power-source-side offsetting extension portion 143 is lengthened.

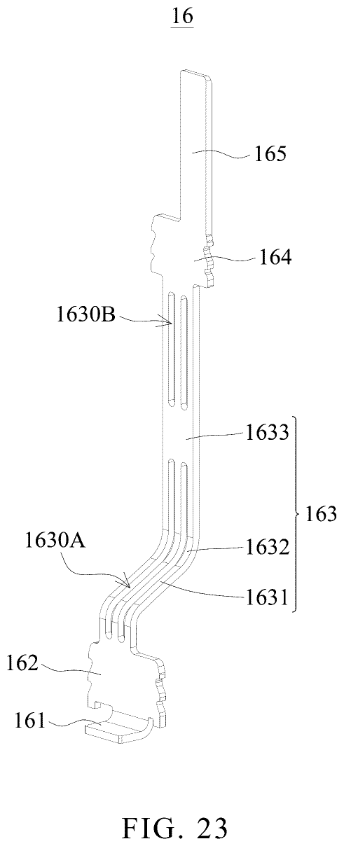

FIG. 23 is a perspective view of a first variant of the power source contact of the floating hybrid connector according to the second embodiment of the present invention. The power source contact according to the first variant is designated as a whole by the reference numeral “16”. The description of the portion of the power source contact 16 similar to the power source contact 14 is omitted. The power source contact 16 has a power-source-side soldered portion 161, a first power-source-side held portion 162, a power-source-side offsetting extension portion 163, a second power-source-side held portion 164, and a power-source-side contact portion 165. A plurality of elongated slots 1630A and 1630B extending longitudinally are formed in the power-source-side offsetting extension portion 163, wherein the elongated slots 1630A are spaced apart from the elongated slots 1630B. The power-source-side offsetting extension portion 163 is weakened by the formation of the elongated slots 1630A and 1630B.

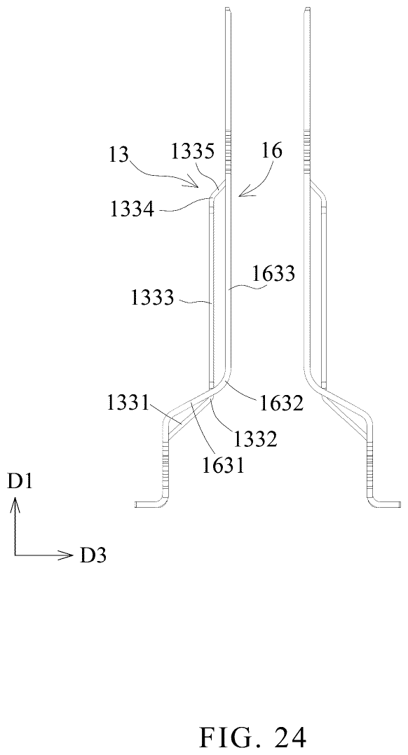

The power-source-side offsetting extension portion 163 has a first extension portion 1631, a bent portion 1632, and a second extension portion 1633. FIG. 24 is a view of the signal contacts 13 of the floating hybrid connector according to the second embodiment and the power source contacts 16 of the first variant, viewed from the second direction D2. As shown in FIG. 24, the second extension portion 1633 is a vertical extension portion extending in the first direction D1 and is aligned with the second power-source-side held portion 164 and the power-source-side contact portion 165. The power-source-side offsetting extension portion 163 of the power source contact 16 is configured such that the vertical extension portion (i.e., the second extension portion 1633) of the power-source-side offsetting extension portion 163 is offset inwardly in the third direction D3 with respect to the vertical extension portion (i.e., the second extension portion 1333) of the signal-side spring portion 133.

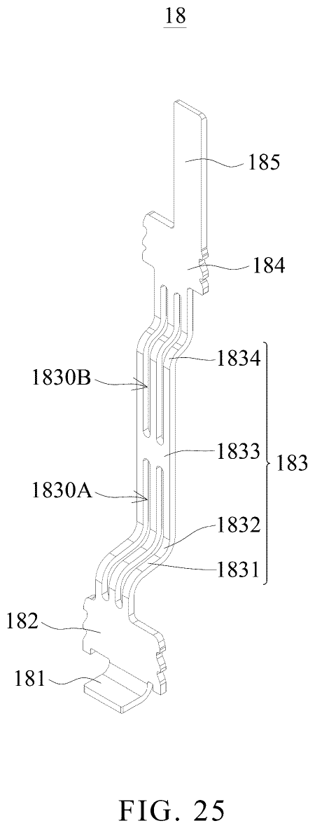

FIG. 25 is a perspective view of a second variant of the power source contact of the floating hybrid connector according to the second embodiment of the present invention. The power source contact according to the second variant is designated as a whole by the reference numeral “18”. The description of the portion of the power source contact 18 similar to the power source contact 14 or 16 is omitted. The power source contact 18 has a power-source-side soldered portion 181, a first power-source-side held portion 182, a power-source-side offsetting extension portion 183, a second power-source-side held portion 184, and a power-source-side contact portion 185. A plurality of elongated slots 1830A and 1830B extending longitudinally are formed in the power-source-side offsetting extension portion 183, wherein the elongated slots 1830A are spaced apart from the elongated slots 1830B. The power-source-side offsetting extension portion 183 is weakened by formation of the elongated slots 1830A and 1830B.

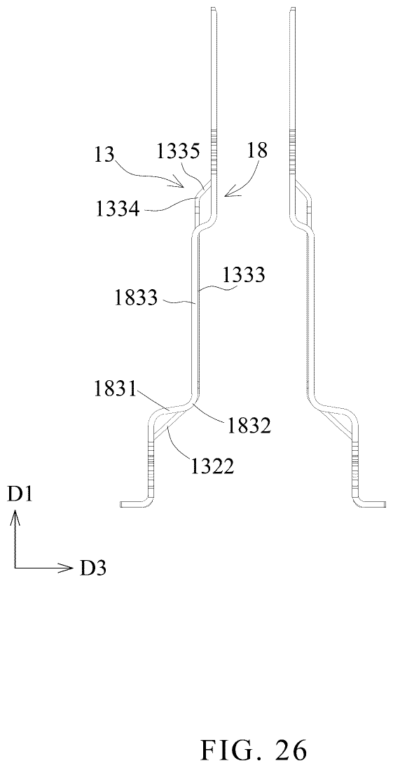

The power-source-side offsetting extension portion 183 has a first extension portion 1831, a first bent portion 1832, a second extension portion 1833, and a second bent portion 1834. FIG. 26 is a view of the signal contacts 13 of the floating hybrid connector according to the second embodiment of the present invention and the power source contacts 18 of the second variant, viewed from the second direction D2. As shown in FIG. 26, the second extension portion 1833 is a vertical extension portion extending in the first direction D1. In FIG. 26, the second extension portion 1833 is not aligned with the second power-source-side held portion 184 and the power-source-side contact portion 185, but is substantially aligned with the second extension portion 1333 of the signal-side spring portion 133.

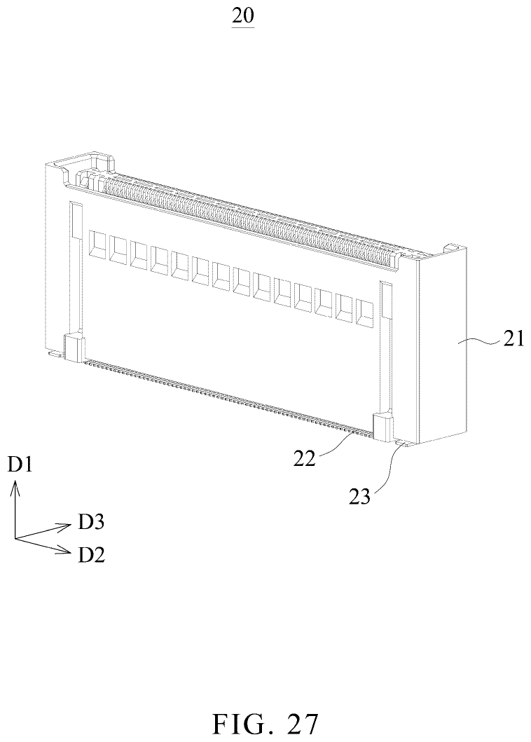

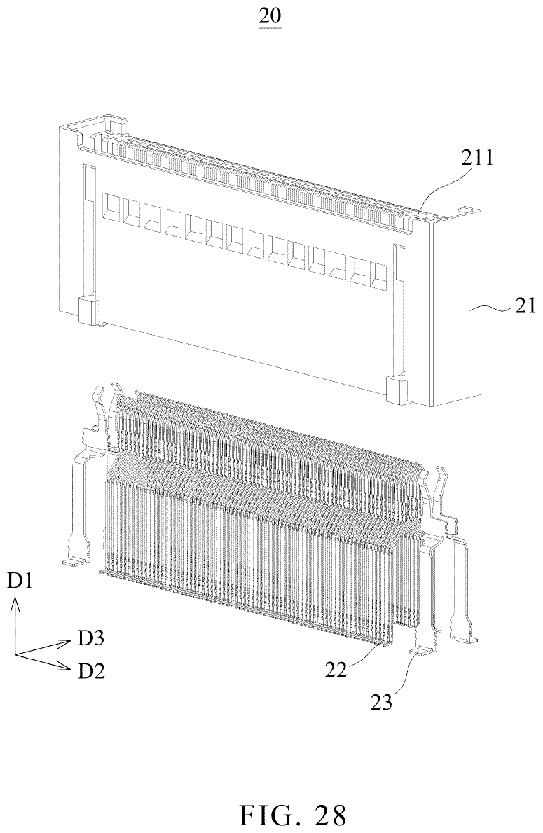

The non-floating hybrid connector 20 will be described with reference to FIGS. 27 and 28, wherein FIG. 27 is a perspective view of the non-floating hybrid connector 20 according to the second embodiment of the present invention, and FIG. 28 is an exploded perspective view of the non-floating hybrid connector 20 according to the second embodiment of the present invention.

The non-floating hybrid connector 20 according to the second embodiment of the present invention comprises an insulating housing 21, a plurality of signal contacts 22, and a plurality of power source contacts 23. The insulating housing 21 is made of insulating resin material or polymer material by injection molding. The signal contacts 22 and power source contacts 23 are made of conductive material (such as copper or copper alloy). The insulating housing 21 is a stationary housing. The insulating housing 21 has a tongue 211 which serves as a mating portion.

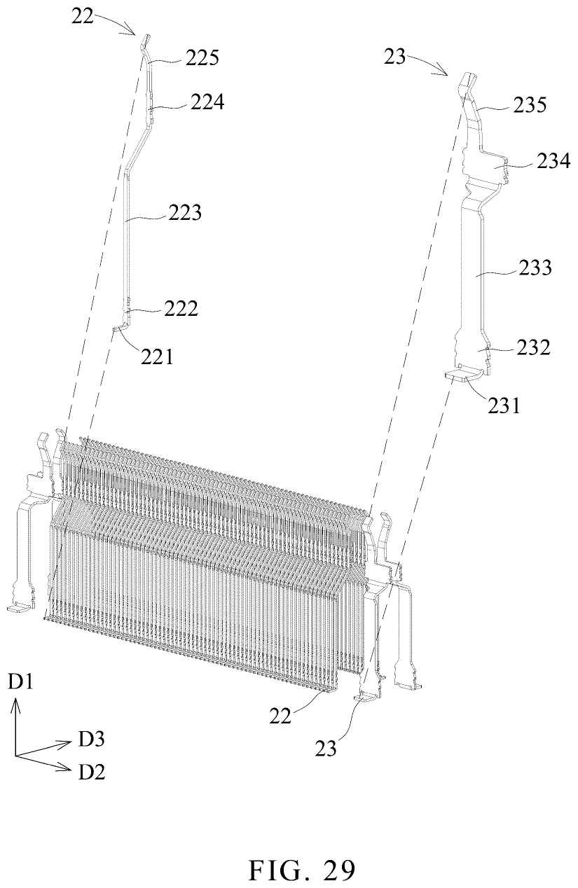

FIG. 29 is a perspective view of the signal contacts 22 and the power source contacts 23 of the non-floating hybrid connector 20 according to the second embodiment of the present invention. As shown in FIG. 29, the signal contacts 22 and the power source contacts 23 are arranged in the second direction D2 perpendicular to the first direction D1 in two rows. The two rows of contacts are mirror-symmetrical to each other. In each row of contacts, two power source contacts 23 are respectively disposed on both sides of a signal contact group formed by signal contacts 22 and spaced apart from the signal contact group. However, the present invention is not limited thereto. The layout of the contacts of the non-floating hybrid connector depends on the layout of the contacts of the floating hybrid connector.

Each signal contact 22 comprises: a signal-side soldered portion 221, a first signal-side held portion 222, a signal-side bent extension portion 223, a second signal-side held portion 224, and a signal-side contact portion 225. The first signal-side held portion 222 extends from the signal-side soldered portion 221. The first signal-side held portion 222 and the second signal-side held portion 224 are connected by the signal-side bent extension portion 223. The signal-side contact portion 225 extends from the second signal-side held portion 224. The signal-side soldered portion 221 will be fixed to the circuit board by using surface mount technology (SMT). The first signal-side held portion 222 and the second signal-side held portion 224 each of which is formed with a barb structure are press-fitted into the insulating housing 21 and are held by the insulating housing 21. Specifically, the first signal-side held portion 222 is fixed near the lower edge of the insulating housing 21, and the second signal-side held portion 224 is fixed to the tongue 211. The signal-side contact portion 225 is positioned on the tongue 211.

Each power source contact 23 comprises: a power-source-side soldered portion 231, a first power-source-side held portion 232, a power-source-side offsetting extension portion 233, a second power-source-side held portion 234, and a power-source-side contact portion 235. The first power-source-side held portion 232 extends from the power-source-side soldered portion 231. The first power-source-side held portion 232 and the second power-source-side held portion 234 are connected by the power-source-side offsetting extension portion 233. The power-source-side contact portion 235 extends from the second power-source-side held portion 234. The power-source-side soldered portion 231 will be fixed to the circuit board by using surface mount technology (SMT). The first power-source-side held portion 232 and the second power-source-side held portion 234 each of which is formed with a barb structure are press-fitted into the insulating housing 21 and are held by the insulating housing 21. Specifically, the first power-source-side held portion 232 is fixed near the lower edge of the insulating housing 21, and the second power-source-side held portion 234 is fixed to the tongue 211. The power-source-side contact portion 235 is positioned on the tongue 211.

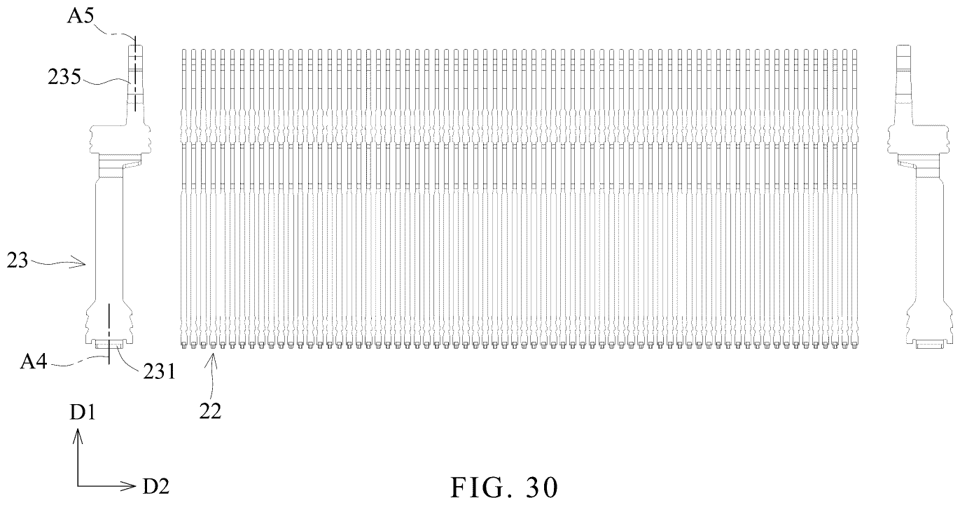

FIG. 30 is a view of the signal contacts 22 and the power source contacts 23 of the non-floating hybrid connector 20 viewed from the third direction D3. As shown in FIG. 30, the central axis A5 of the power-source-side contact portion 235 is offset inwardly in the second direction D2 with respect to the central axis A4 of the power-source-side soldered portion 231. With aid of offsetting of the power-source-side contact portion 235 with respect to the power-source-side soldered portion 231, even if the solder pad layout of the circuit board is predetermined (i.e., the gap between the signal contacts and power source contacts on the soldered side is predetermined and cannot be changed), the power source contacts can be used to adjust the gap between the signal contacts and power source contacts on the contact side so that the gap on the contact side can match that of the floating hybrid connector.

While this invention has been described in reference to a preferred embodiment, it should be understood that numerous changes and modifications could be made within the spirit and scope of the inventive concepts described. Accordingly, it is intended that the invention not be limited to the disclosed embodiment, but that it have the full scope permitted by the language of the following claims.

What is claimed is:

1. A hybrid connector, comprising an insulating housing, a plurality of signal contacts and a plurality of power source contacts, the insulating housing having a mating portion mateable with a mating connector in a first direction,
wherein the plurality of signal contacts and the plurality of power source contacts are arranged in a second direction perpendicular to the first direction, and the plurality of power source contacts are disposed on both sides of a signal contact group formed by the plurality of signal contacts and spaced apart from the signal contact group; and
each power source contact includes a power-source-side soldered portion at one end and a power-source-side contact portion at the other end, when viewed from a third direction perpendicular to both the first direction and second direction, a central axis of the power-source-side contact portion is offset inwardly with respect to a central axis of the power-source-side soldered portion in the second direction, so that a gap between the power-source-side soldered portion and the signal contact group is greater than a gap between the power-source-side contact portion and the signal contact group.

2. The hybrid connector of claim 1, wherein each power-source-side contact comprises: the power-source-side soldered portion, a first power-source-side held portion, a power-source-side offsetting extension portion, a second power-source-side held portion and the power-source-side contact portion, the first power-source-side held portion and the second power-source-side held portion are held by the insulating housing, the first power-source-side held portion extends from the power-source-side soldered portion, the first power-source-side held portion and the second power-source-side held portion are connected by the power-source-side offsetting extension portion, the power-source-side contact portion extends from the second power-source-side held portion,
the central axis of the power-source-side contact portion is offset inwardly in the second direction with respect to the central axis of the power-source-side soldered portion by means of the power-source-side offsetting extension portion.

3. The hybrid connector of claim 2, wherein the insulating housing is composed of a first housing and a second housing, the second housing is mounted to the first housing in such a manner that the second housing is immovable with respect to the first housing.

4. The hybrid connector of claim 3, wherein the plurality of signal contacts and the plurality of power source contacts are held by the second housing.

5. The hybrid connector of claim 3, wherein the first housing is in form of an outer frame, and one end of the second housing is in form of a tongue.

6. The hybrid connector of claim 5, wherein the tongue serves as the mating portion.

7. The hybrid connector of claim 2, wherein the insulating housing comprises a first housing and a second housing, and the second housing is mounted to the first housing in such a manner that it is movable in a plane perpendicular to the first direction.

8. The hybrid connector of claim 7, wherein the first power-source-side held portion is held by the first housing, the second power-source-side held portion is held by the second housing, and the power-source-side offsetting extension portion serves as a power-source-side spring portion.

9. The hybrid connector of claim 8, wherein each signal contact comprises: a signal-side soldered portion, a first signal-side held portion, a signal-side spring portion, a second signal-side held portion and a signal-side contact portion, the first signal-side held portion is held by the first housing, the second signal-side held portion is held by the second housing, the first signal-side held portion extends from the signal-side soldered portion, the first signal-side held portion and the second signal-side held portion are connected by the signal-side spring portion, and the signal-side contact portion extends from the second signal-side held portion.

10. The hybrid connector of claim 7, wherein the mating portion is formed on the second housing.

11. A hybrid connector, comprising a first housing, a second housing, a plurality of signal contacts and a plurality of power source contacts, the second housing having a mating portion mateable with a mating connector in a first direction, the second housing being mounted to the first housing in such a manner that it is movable in a plane perpendicular to the first direction with respect to the first housing,
wherein the plurality of signal contacts and the plurality of power source contacts are arranged in a second direction perpendicular to the first direction, and the plurality of power source contacts are disposed on both sides of a signal contact group formed by the plurality of signal contacts and spaced apart from the signal contact group;
each signal contact includes: a signal-side soldered portion, a first signal-side held portion, a signal-side spring portion, a second signal-side held portion and a signal-side contact portion, the first signal-side held portion is held by the first housing, the second signal-side held portion is held by the second housing, the first signal-side held portion extends from the signal-side soldered portion, the first signal-side held portion and the second signal-side held portion are connected with each other by the signal-side spring portion, and the signal-side contact portion extends from the second signal-side held portion;
each power source contact includes: a power-source-side soldered portion, a first power-source-side held portion, a power-source-side offsetting extension portion, a second power-source-side held portion and a power-source-side contact portion, the first power-source-side held portion is held by the first housing, the second power-source-side held portion is held by the second housing, the first power-source-side held portion extends from the power-source-side soldered portion, the first power-source-side held portion and the second power-source-side held portion are connected with each other by the power-source-side offsetting extension portion, and the power-source-side contact portion extends from the second power-source-side held portion; and
wherein a central axis of the power-source-side offsetting extension portion is offset inwardly in the second direction with respect to a central axis of the power-source-side soldered portion when viewed from a third direction perpendicular to the first direction and the second direction.

12. The hybrid connector of claim 11, wherein each signal contact has a first width, and each power source contact has a second width which is greater than the first width.

13. The hybrid connector of claim 12, wherein the power-source-side offsetting extension portion is formed with a plurality of elongated slots.

14. The hybrid connector of claim 11, wherein the central axis of the power-source-side offsetting extension portion is offset inwardly in the second direction with respect to a central axis of the power-source-side contact portion when viewed from the third direction.

15. The hybrid connector of claim 11, wherein the plurality of signal contacts and the plurality of power source contacts are arranged in the second direction in two rows.

16. The hybrid connector of claim 11, wherein the signal-side spring portion is bent differently from the power-source-side offsetting extension portion when viewed from the second direction.

17. The hybrid connector of claim 11, wherein the power-source-side offsetting extension portion extends longer than the signal-side spring portion.

18. The hybrid connector of claim 11, wherein the signal-side spring portion has a signal-side vertical extension portion extending in the first direction, the power-source-side offsetting extension portion has a power-source-side vertical extension portion extending in the first direction, and the power-source-side vertical extension portion is offset inwardly in the third direction with respect to the signal-side vertical extension portion when viewed from the second direction.
